(19) United States
(12) Patent Application Publication
(10) Pub. No.: US 2008/0134318 A1
(43) Pub. Date: Jun. 5, 2008

(54) AUTHENTICATION DEVICE, AUTHENTICATION METHOD, AUTHENTICATION PROGRAM AND COMPUTER-READABLE RECORDING MEDIUM STORING THE SAME

(76) Inventors: Yoshiharu YOSHIMOTO, Tenri-shi (JP); Masahiro Ueda, Kashiba-shi (JP)

Correspondence Address: BIRCH STEWART KOLASCH & BIRCH, PO BOX 747, FALLS CHURCH, VA, 22040-0747, US

(21) Appl. No.: 11/949,601

(22) Filed: Dec. 3, 2007

(30) Foreign Application Priority Data
Dec. 5, 2006 (JP) 2006-328653
Nov. 13, 2007 (JP) 2007-294896

(51) Int. Cl. H04L 9/32; G06F 7/04

(52) U.S. Cl. 726/19

(57) ABSTRACT

An authentication device 1 includes: a display input device 3 that obtains numerical values of plural number keys, which numerical values are entered simultaneously via the number keys; a calculating section 9 that determines an input password by calculating, in accordance with a predetermined calculation method, the plural numerical values entered into the display input device 3; and a password verifying section 10 that verifies the input password determined by the calculating section 9 against a predetermined verification password. This make it possible to prevent, while keeping the passwords easy for the users to memorize, third parties from stealing the passwords by looking at how the users move their fingers and arms, and also to prevent the third parties from misusing the passwords even if the third parties figure out the passwords through memos or the Internet.

This Nonprovisional application claims priority under 35 U.S.C. § 119(a) on Patent Applications No. 328653/2006 filed in Japan on Dec. 5, 2006, and No. 294896/2007 filed in Japan on Nov. 13, 2007, the entire contents of which are hereby incorporated by reference.

### FIELD OF THE INVENTION

The present invention relates to an authentication device, an authentication method, an authentication program, and a computer-readable recording medium, by which a password is prevented from being stolen or misused by third parties.

### BACKGROUND OF THE INVENTION

For example automated teller machines (ATM) of banks and equipments for opening doorways to controlled areas usually require information for authentication, such as passwords, to be given. To give a higher priority on the user convenience, the passwords are each constituted of approximately four digits from “0” to “9” to allow the users to memorize the passwords easily.

The password constituted of approximately four digits is easy for the users to memorize. However, there is a possibility that a third party easily steals the password by looking at how the user operates to enter the password.

Publications 1 to 4 disclose conventional techniques that make it difficult for the third parties to steal the passwords by looking at how the users move their fingers and arms when entering the passwords.

The inventions described in Publication 1 (Japanese Unexamined Patent Publication No. 20468/2000 (Tokukai 2000-20468) (publication date: Jan. 21, 2000)) and Publication 2 (Japanese Unexamined Patent Publication No. 196006/2003 (Tokukai 2003-196006) (publication date: Jul. 11, 2003)) employ conventional passwords each constituted of approximately four digits, and change entry screens to prevent the passwords from being stolen by the third parties.

The inventions described in Publication 3 (Japanese Unexamined Patent Publication No. 345206/1999 (Tokukaihei 11-345206) (publication date: Dec. 14, 1999)) and Publication 4 (Japanese Unexamined Patent Publication No. 344058/2001 ((Tokukai 2001-344058) (publication date: Dec. 14, 2001)) employ passwords each constituted of images or the like other than numbers, in order to prevent the passwords from being stolen. The following concretely describes the techniques of Publications 1 to 4.

Publication 1 discloses an information input device that allows the users to enter secret information through simple and easy operation, without an increase in operational burden on the users. At the same time, the information input device makes it possible to avoid the risks of leakage of the secret information by the third parties through movement analysis. The information input device is arranged in such a manner that, each time when an identification number is to be entered with the keys, a display position of an identification-number entry screen and respective display positions of the keys, or either of the display position of the identification-number entry screen and the display positions of the keys, are determined randomly to display them.

Publication 2 discloses an identification number input device that prevents, while keeping a decrease in operability to a minimum, other people from figuring out the identification numbers by looking at how the users move their fingers and arms when entering the identification numbers into the entry operation screen, such as ten-keys arranged in matrix. The identification number input device includes a display device that shows plural keys arranged in matrix, a key operation detecting section that detects an operation to select any of the keys, and a key display controlling section that controls respective display positions of the keys on the screen of the display device. Each time when the key operation detecting section detects an operation to select a key, the key display controlling section moves the display positions of either all of or some of the plural keys in the direction of rows or columns.

Publication 3 discloses an electronic information management system by which plural particular sections of plural images are designated to increase combinations of image parameters drastically so that it becomes difficult for the third parties to steal passwords. In a case in which a password to be used is designation of images, the electronics information management system is arranged as follows to make the password easy to memorize and difficult to steal. When a user name is entered, at least one image and mesh are shown. When particular sections of the image are designated, an image password is created on the basis of the particular sections thus designated and an order of this designation. If the image password is correct, and if there is an image (transition image) to be displayed next, then transition information that is registered is obtained, and it returns to an image mesh display. If there is no transition image, then encrypted information that is registered is decrypted into non-encrypted information, and the non-encrypted information is output.

Publication 4 discloses an identification number input device by which movement of fingers of a user is concealed when the user enters an identification number. This makes it difficult for the third parties to figure out the identification number by looking at how the user enters the identification number. Further, the user memorizes the identification number in the form of sensations in the hand of the user. This makes it difficult for the third parties to figure out the identification number. Buttons of the identification number input device that are used when the user enters the identification number have no letter, symbol, or alphabet corresponding to the identification number, and are arranged randomly. Further, the identification number input device includes a concealing case to conceal the movement of the fingers.

As described above, according to the techniques disclosed in Publications 1 and 2, the key configurations are changed to prevent the third parties from figuring out the passwords by looking at how the users move their fingers and arms when entering the passwords. However, changing the key configurations each time requires the users to look for the positions of the target keys. This impairs the user convenience. Further, if the key configurations are changed systematically and simply enough, there is a possibility that the third parties figure out the passwords.

Further, according to the technique disclosed in Publication 3, the positions of the images are designated to significantly increase the number of combinations of the image parameters so that it becomes difficult for the third parties to steal the passwords. However, since images are distinctive, it is easy for the third parties to figure out which parts of the images are pressed by looking at the screen.

Further, according to the technique disclosed in Publication 4, the concealing case is provided so that it becomes possible to prevent the passwords from being observed. However, since the passwords cannot be constituted of numbers or alphabets, it is difficult to memorize the passwords. This sacrifices the user convenience.

With the techniques disclosed in Publications 1 to 4, even if the third parties are prevented from stealing the passwords by looking at the passwords, there is still a possibility that the third parties misuse the passwords if the passwords are known through memos or the Internet, unless the passwords are invalidated. Furthermore, it is difficult to immediately notice that the passwords are known by the third parties. This causes delays in invalidating the passwords. Thus, there is a high possibility that the third parties misuse the passwords.

### SUMMARY OF THE INVENTION

The present invention is in view of the foregoing problems and has as an object to provide an authentication device, an authentication method, an authentication program, and a computer-readable recording medium storing the program, by which it becomes possible to prevent, while keeping passwords easy for users to memorize, third parties from stealing the passwords by looking at how users move their fingers and arms, and also to prevent the third parties from misusing the passwords even if the third parties figure out the passwords through memos or the Internet.

To achieve the above object, an authentication device of the present invention is adapted so that the authentication device includes: input means for obtaining plural numerical values of plural keys, which plural numerical values are entered simultaneously via the plural keys; calculating means for determining an input password by performing calculation according to a predetermined calculation method by use of the plural numerical values obtained by the input means; and verifying means for verifying the input password determined by the calculating means, against a verification password that is determined in advance.

The calculation method is to determine how the input values that are entered simultaneously by the user are used in the calculation to determine the input password. Examples of the calculation method include “addition”, “subtraction”, “multiplication”, and “division”. Further, the “input password” is a value obtained by the calculation according to the predetermined calculation method by use of the numerical values that are entered simultaneously. The calculation method may be determined in advance, or may be designated by either the user or the authentication device each time when the authentication is to be carried out.

With the foregoing configuration, the user presses the plural keys simultaneously, and the numerical values thus entered simultaneously are used in the calculation according to the predetermined calculation method, whereby the input password is determined. The input password is verified against the predetermined verification password. That is to say, the numerical values different from the password are simultaneously entered at one time in the present invention, whereas each digit of the password itself is entered in the conventional ways, when the user enters the password.

Accordingly, the keys that the user presses simultaneously are not the input password itself. Therefore, even if the third parties see the user performing input operation, the password is prevented from being stolen by the third parties. Further, the user enters plural keys at the same time. This makes it difficult to identify which keys are pressed, when the third parties try to figure out the input value by looking at the movement of the fingers and arms of the user. Thus, it becomes possible to prevent the input value from being stolen easily by the third parties.

Further, even if the password itself is known by the third parties through memos or the Internet, the third parties are unable to enter appropriate numerical values to derive the password unless the third parties know the calculation method to obtain the password. This makes it possible to prevent the password from being stolen easily by the third parties.

Further, although the number of number keys that the user need to press is a lot, the password that the user needs to memorize may be a simple password of numerical values that are easy to memorize, in the same manner as in conventional methods. This, therefore, does not give burden on the user and is convenient for the user.

An authentication method of the present invention is adapted so that the method includes: an entry step of obtaining plural numerical values of plural keys, which plural numerical values are entered simultaneously via the plural keys; a calculation step of determining an input password by performing calculation according to a predetermined calculation method by use of the plural numerical values obtained in the entry step; and a verification step of verifying the input password determined in the calculation step, against a verification password that is determined in advance.

With this method, the user presses the plural keys simultaneously, and the numerical values thus entered simultaneously are used in the calculation according to the predetermined calculation method, whereby the input password is determined. The input password is verified against the predetermined verification password. That is to say, the numerical values different from the password are simultaneously entered at one time in the present invention, whereas each digit of the password itself is entered in the conventional ways, when the user enters the password.

Accordingly, the keys that the user presses simultaneously are not the input password itself. Therefore, even if the third parties see the user performing input operation, the password is prevented from being stolen by the third parties. Further, even if the password itself is known by the third parties through memos or the Internet, the third parties are unable to enter appropriate numerical values to derive the password unless the third parties know the calculation method to obtain the password. This makes it possible to prevent the password from being stolen easily by the third parties.

Further, the user enters plural number keys at the same time so that it becomes difficult to identify which number keys are pressed when the third parties try to figure out the input value by looking at the movement of the fingers and arms of the user. This makes it possible to prevent the input value from being stolen easily by the third parties.

Further, although the number of keys that the user need to press is a lot, the password that the user needs to memorize may be a simple password of numerical values that are easy to memorize, in the same manner as in conventional methods. This, therefore, does not give burden on the user and is convenient for the user.

As the foregoing describes, the authentication device of the present invention includes: input means for obtaining plural numerical values of plural keys, which plural numerical values are entered simultaneously via the plural keys; calculating means for determining an input password by performing calculation according to a predetermined calculation method by use of the plural numerical values obtained by the input means; and verifying means for verifying the input password determined by the calculating means, against a verification password that is determined in advance.

Further, the authentication method of the present invention includes: an entry step of obtaining plural numerical values of plural keys, which plural numerical values are entered simultaneously via the plural keys; a calculation step of determining an input password by performing calculation according to a predetermined calculation method by use of the plural numerical values obtained in the entry step; and a verification step of verifying the input password determined in the calculation step, against a verification password that is determined in advance.

Thus, it is possible to prevent, while keeping the passwords easy for the users to memorize, the third parties from stealing the passwords by looking at how the users move their fingers and arms. It is also possible to prevent the third parties from misusing the passwords even if the third parties figure out the passwords through memos or the Internet.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating a schematic configuration of an authentication device in accordance with an embodiment of the present invention.

FIG. 2 is a figure illustrating a schematic configuration of an ATM to which the authentication device is applied.

FIG. 3 is a figure illustrating an information entry screen shown on a display device of the authentication device.

FIG. 4 is a figure illustrating a user information table that is stored in a user information DB of the authentication device.

FIG. 5 is a figure illustrating how simultaneous inputs are to be made with an information entry screen shown on the display device of the authentication device.

FIG. 6 is a flowchart showing a process carried out in the authentication device.

FIG. 7 is a flowchart showing how authentication is carried out in the process.

FIG. 8 is a figure illustrating a relationship between input values that are entered simultaneously and output values in the authentication device.

FIG. 9 is a figure illustrating the information entry screen shown on the display device of the authentication device.

FIG. 10 is a figure illustrating a configuration in which an input instructing section causes one number key to flush on the information entry screen shown on the display device of the authentication device.

FIG. 11 is a figure illustrating a configuration in which the input instructing section causes plural number keys to flush on the information entry screen shown on the display device of the authentication device.

FIG. 12 is a figure illustrating a configuration in which the calculation method is selectable on the information entry screen shown on the display device of the authentication device.

### DESCRIPTION OF THE EMBODIMENTS

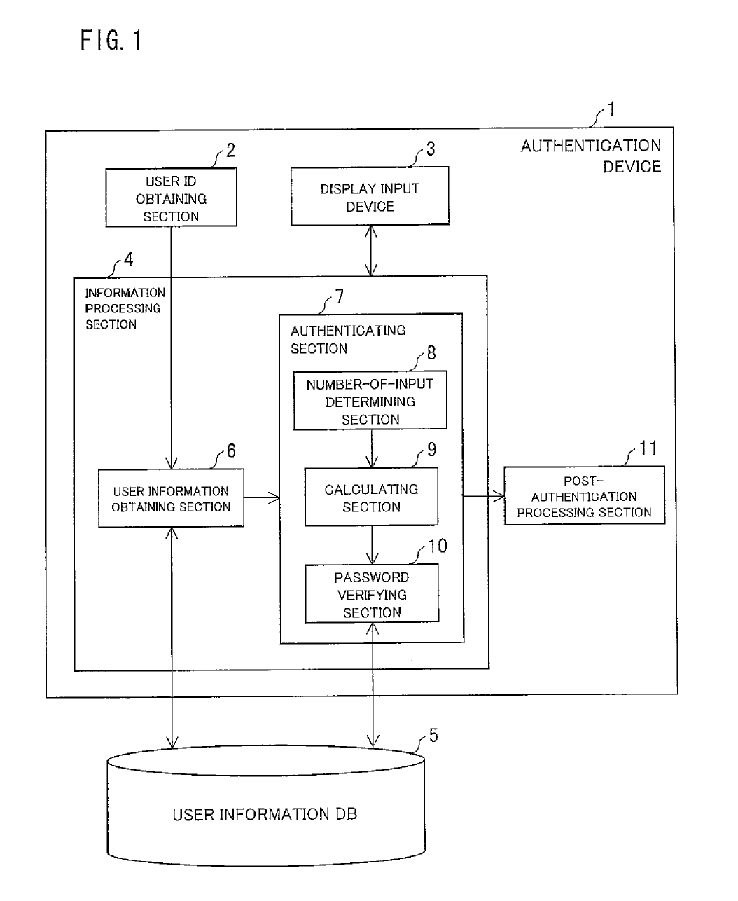

The following describes an embodiment of the present invention, with reference to FIGS. 1 to 10.

FIG. 1 is a block diagram illustrating a schematic configuration of an authentication device 1 in accordance with an embodiment of the present invention. First, an overall configuration of the authentication device 1 will be described.

As shown in FIG. 1, the authentication device 1 includes a user ID obtaining section (user identification information obtaining means) 2, a display input device (input means) 3, an information processing section 4, and a post-authentication processing section 11. A user information DB (database) (storage section) 5, which stores a user information table, is provided outside of the authentication device 1, and is connected to the information processing section 4 via a network.

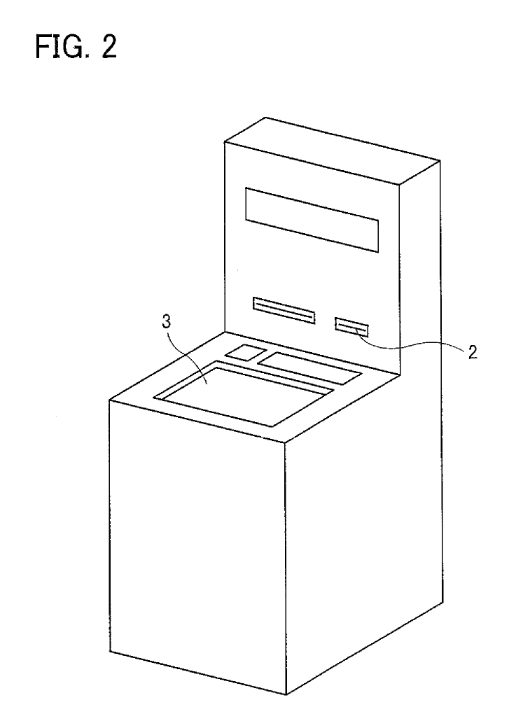

The authentication device 1 is installed in devices that require passwords or the like to be entered for authentication, such as ATM shown in FIG. 2, PC, and mobile phones.

The user ID obtaining section 2 obtains a user ID to identify a user. The user ID obtaining section 2 may be arranged in such a manner that a user directly enters a user ID. It is also possible to arrange the user ID obtaining section 2 in such a manner that an IC card or the like storing a user ID is inserted into a reading device (not illustrated) so that the user ID is read out from the IC card.

The display input device 3 displays operational instructions to the user, status of information processing, error messages when errors occur in information entered, and the like. Further, the display input device 3 includes a touch panel and the like, and obtains numerical values of arbitrary plural number keys that the user enters simultaneously.

The keys that the user uses when entering plural values do not always have to be the number keys, and any other keys may be used. In this case, particular keys need to be associated in advance with specific values, and the user needs to know in advance which keys need to be pressed to enter which values. It is preferable in view of saving the troubles for the user that the keys be number keys.

Touch panels using cathode ray tubes (CRT) or liquid crystal displays (LCD) are suitably used as the display input device 3 in the present embodiment. Among the touch panels using liquid crystal displays, especially a touch panel using a light sensor provided in a liquid crystal display to simultaneously detect plural points that are pressed is suitably employed. Such touch panels are disclosed concretely in Japanese Unexamined Patent Publication No. 318819/2004 (Tokukai 2004-318819) (publication date: Nov. 11, 2004).

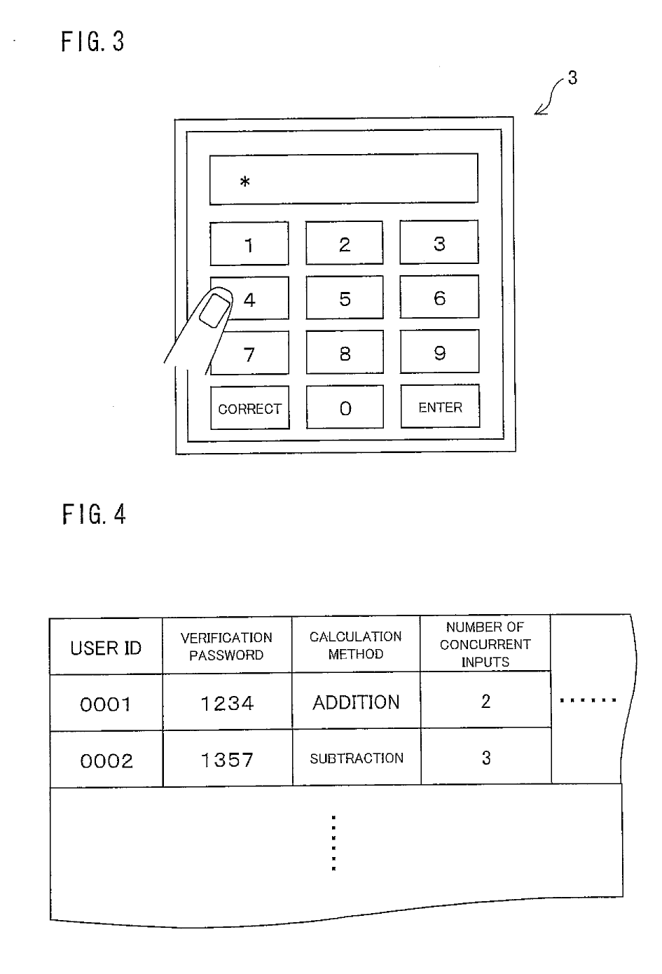

The display input device 3 in the present embodiment displays an information entry screen as shown in FIG. 3, when the user enters information to determine an input password. The information entry screen is constituted of number keys “0” to “9”, a “correct” key and an “enter” key, all of which are arranged in matrix of four rows by three columns. The number keys are arranged in ascending order from the top according to the numerical values of the number keys so that the user can easily select any numbers. Further, display boxes are provided above the keys to display the numerical values of the number keys that the user enters. It should be noted that the combinations and configurations of the keys are not limited to the foregoing combinations and configurations. Further, keys that play other roles, such as a “return” key and a “clear” key, may be added if necessary.

The display input device 3 is not limited to the touch panels described above. An information input section (e.g. keyboards) for obtaining numerical values of any number keys that the user enters simultaneously and a display section (e.g. displays) that displays various information may be provided separately, as the way they are provided in PC or mobile phones, or the display section may be omitted. The display input device 3 only needs to be arranged in such a manner that at least respective numerical values of plural number keys that are pressed simultaneously are obtainable.

The user information DB 5 stores various user information. A user information table as shown in FIG. 4 on which “user ID”, “verification password”, “calculation method” and “the number of simultaneous inputs” are associated is stored in the user information DB 5. FIG. 4 is a figure illustrating a user information table that is stored in the user information DB 5 of the authentication device 1. Although the user information DB 5 is provided outside of the authentication device 1 in the present embodiment, the present invention is not limited to this configuration, and the user information DB 5 may be provided inside of the authentication device 1.

The “user ID” is a sign to identify the user. The “verification password” is a preset combination of numerical characters. The “calculation method” is to determine how to calculate the input values that the user enters simultaneously, in order to calculate the input password. Examples of the “calculation method” include “addition”, “subtraction”, “multiplication”, “division” and the like. Further, “the number of simultaneous inputs” is the number of number keys that the user presses simultaneously. “The number of simultaneous inputs” only needs to be 2 or more. The “input password” is a value obtained by calculation according to the calculation method corresponding to the user ID by use of the numerical values that are entered simultaneously.

More specifically, the input password is a configuration of numerical characters that is formed by arranging plural numerical characters.

The information processing section 4 includes a user information obtaining section 6 and an authenticating section 7. On the basis of the user ID obtained by the user ID obtaining section 2, the information processing section 4 determines the input password by use of the numerical values obtained by the display input device 3, and verifies the input password against the verification password.

The user information obtaining section 6 is connected to the user information DB 5 via networks. The user information obtaining section 6 obtains the user ID from the user ID obtaining section 2, and obtains, from the user information table stored in the user information DB 5, the number of simultaneous inputs and the calculation method that correspond to the user ID. Further, the user information obtaining section 6 obtains the number of number keys that are pressed simultaneously and the numerical values that are entered simultaneously, which number and numerical values have been obtained by the display input device 3, and compares the number of user inputs, which number is the total number of numerical values that are entered simultaneously, with the predetermined number of inputs, which predetermined number is based on the number of simultaneous inputs and the verification password. The predetermined number of inputs indicates the number of numerical values that the user needs to enter. The number of numerical values is determined on the basis of the number of simultaneous inputs and the number of numerical characters that constitute the verification password.

The authenticating section 7 includes a number-of-input determining section (input determining means) 8, a calculating section (calculating means) 9, and a password verifying section (verifying means) 10. The authenticating section 7 determines whether or not the number of number keys that are pressed simultaneously matches the number of simultaneous inputs that corresponds to the user ID. If the number of number keys matches the number of simultaneous inputs, then the authenticating section 7 determines the input password and verifies the input password against the verification password. After this verification, if the input password matches the verification password, then the authenticating section 7 makes the post-authentication processing section 11 carry out various processes.

Specifically, the number-of-input determining section 8 obtains, from the user information obtaining section 6, the number of number keys that are pressed simultaneously and the number of simultaneous inputs, and determines whether the number of number keys that are pressed simultaneously matches the number of simultaneous inputs.

If the number-of-input determining section 8 determines that the number of number keys that are pressed simultaneously matches the number of simultaneous inputs, then the calculating section 9 obtains, from the user information obtaining section 6, the numerical values that are entered simultaneously and the calculation method, and performs calculation according to the calculation method by use of the numerical values, thereby determining the input password.

More specifically, the calculating section 9 determines, from a group of plural numerical values that are entered simultaneously via the display device 3, at least one of the plural numerical characters constituting the input password.

The password verifying section 10 verifies the input password, which is determined by the calculating section 9, against the verification password stored in the user information DB 5. The password verifying section 10 is connected to the user information DB 5 via networks. When obtaining the user ID from the user information obtaining section 6, the password verifying section 10 obtains, from the user information DB 5, the verification password that corresponds to the user ID. Then, the password verifying section 10 obtains the input password from the calculating section 9, and verifies the input password against the verification password obtained from the user information DB 5.

The post-authentication processing section 11 carries out various processes when the password verifying section 10 determines that the input password matches the verification password. For example in the case in which the authentication device 1 of the present embodiment is installed in ATM, the post-authentication processing section 11 carries out withdrawal of cash. In the case in which the authentication device 1 is installed in an opening device of an entrance door to a controlled area, the post-authentication processing section 11 carries out a process of opening the entrance door to the controlled area.

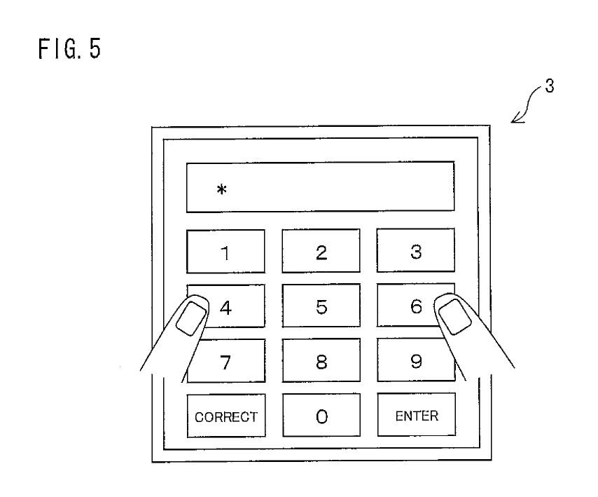

The following describes, with reference to FIG. 5, how the calculating section 9 determines the input password by use of the numerical values that are entered simultaneously, on the basis of the number of simultaneous inputs and in accordance with the calculation method. FIG. 5 is a figure illustrating how inputs are entered simultaneously with the information entry screen shown on the display input device 3 of the authentication device 1. The following discusses a case in which the calculation method corresponding to the user ID of the user who operates the authentication device 1 is set to addition, the number of simultaneous inputs is set to 2, and the first digit of the verification password is set to “0”.

As shown in FIG. 5, when the user simultaneously presses the number keys of “4” and “6” shown on the information entry screen of the display input device 3 to enter the numerical values for determining the first digit of the input password, the calculating section 9 calculates “4+6” in accordance with the addition, which is the predetermined calculation method. The result of this calculation is 10. In the present embodiment, if the number of digits is two, the value of the last digit is adopted as the output value. The first digit of the input password is therefore “0”. The input password of a predetermined number of digits is determined accordingly.

Further, suppose that the calculation method is subtraction, and the number of simultaneous inputs is “2”. In this case, if “4” and “6” are entered simultaneously, “4” which is a smaller numerical value is subtracted from “6” which is a greater numerical value, and “2” which is a result of this calculation is adopted as the output value.

Further, suppose that the calculation method is multiplication, and the number of simultaneous inputs is “2”. In this case, if “4” and “6” are entered simultaneously, “24” is obtained as a result of this calculation, and “4” which is the last digit of “24” is adopted as the output value.

Further, suppose that the calculation method is division, and the number of simultaneous inputs is “2”. In this case, if “4” and “6” are entered simultaneously, “6” which is a larger numerical value is divided by “4” which is a smaller numerical value. The result of this calculation is “1” with a residual value “2”. The residual value “2” is adopted as the output value.

Although the last digit of the result of calculation is adopted as the output value obtained by the calculation method in the present embodiment, the output value is not limited to the foregoing output value. For example if the result of calculation is a numerical value of two digits, the first digit may be adopted as the output value, or the numerical value of two digits may be adopted as the output value without changing the numerical value so that two digits of the password are entered by one input.

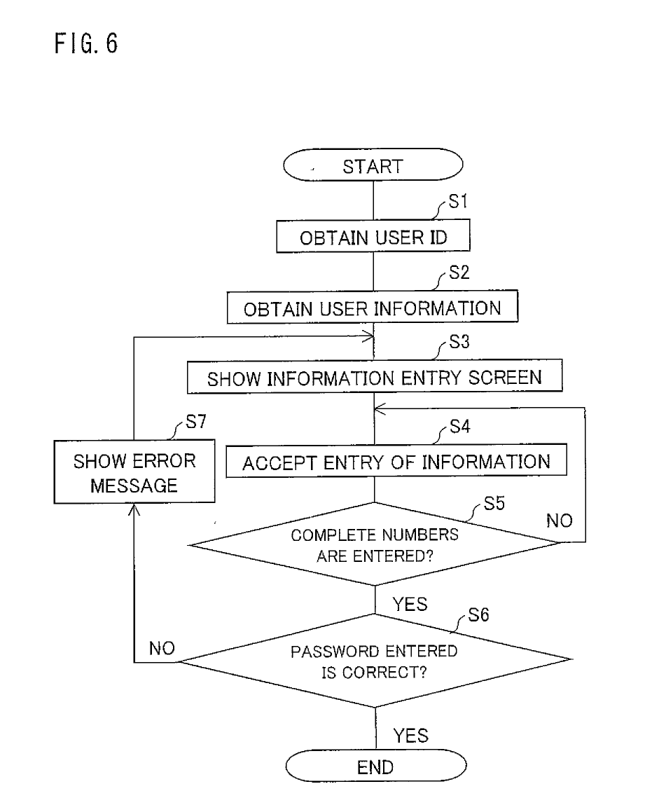

The following describes a process carried out in the authentication device 1 of the present embodiment, from the step in which the user ID obtaining section 2 obtains the user ID to the step in which the password verifying section 10 verifies the input password against the verification password, with reference to FIGS. 1 and 6. FIG. 6 is a flowchart showing a process carried out by the authentication device 1 of the present embodiment. The following discusses a process in a case in which the user identified by user ID “0001” shown in FIG. 4 operates the authentication device 1.

As shown in FIG. 6, the user inserts an IC card into the user ID obtaining section 2 of the authentication device 1, and the user ID obtaining section 2 reads out the user ID from the IC card and supplies the user ID to the user information obtaining section 6 (S1).

The user information obtaining section 6 then obtains, from the user information table stored in the user information DB 5, the calculation method and the number of simultaneous inputs, which method and number correspond to the user ID obtained from the user ID obtaining section 2 (S2). Since the user ID is “0001”, the calculation method is addition, and the number of simultaneous inputs is 2.

Having obtained the calculation method and the number of simultaneous inputs, the user information obtaining section 6 causes the display input device 3 to display the information entry screen (S3), and make the information entry screen wait until the user makes an input (S4).

When the user makes an input, the user information obtaining section 6 obtains the number of number keys that are pressed simultaneously and the numerical values that are entered simultaneously, which number and the numerical values have been obtained by the display input device 3, and compares the number of user inputs with the predetermined number of inputs (S5). If, for example, the user ID is “0001”, the number of simultaneous inputs is “2”, and the verification password is “1234”, which has four digits. Thus, the predetermined number of inputs is “8”. If the number of user inputs does not match the predetermined number of inputs (NO in S5), then the process returns to S4.

The user information obtaining section 6 may be configured in such a manner that, when the user enters the numerical values for determining a digit of the input password, that is to say each time when the numerical values are entered simultaneously, the display input device 3 is caused to show a display indicating that the numerical values are entered to determine which one of the digits of the input password.

If the number of user inputs matches the predetermined number of inputs (YES in S5), then the user information obtaining section 6 supplies, to the authenticating section 7, the number of number keys that are pressed simultaneously, the numerical values that are entered simultaneously, the number of simultaneous inputs and the calculation method. On the basis of those information, the authenticating section 7 then determines the input password and verifies the input password against the verification password stored in the user information DB 5 (S6).

If determining that the input password does not match the verification password (NO in S6), then the authenticating section 7 transmits, to the display input device 3, information about authentication failure, causes an error message to be displayed, and then causes the information entry screen to be displayed again (S7).

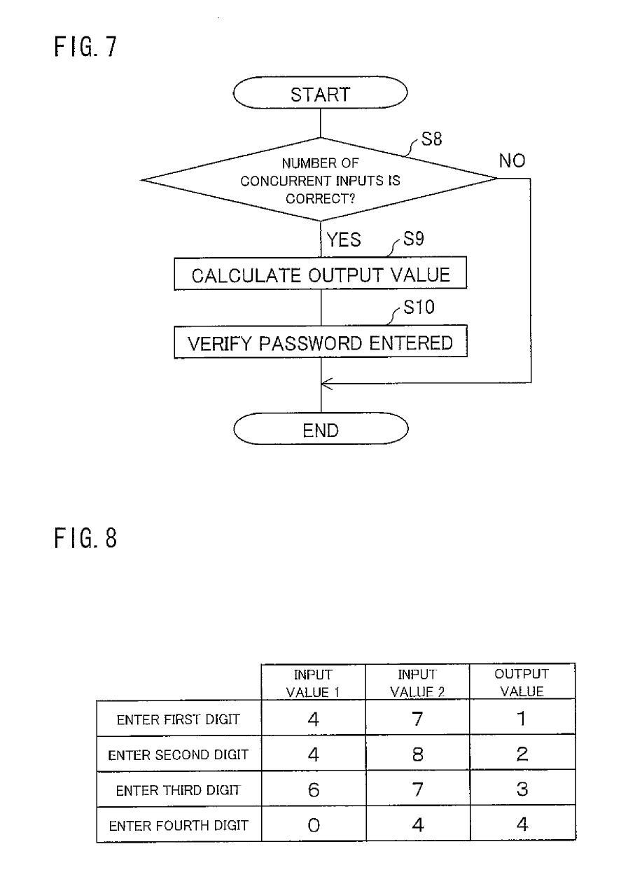

The following concretely describes a process of authenticating the input password and the verification password in S6 and S7 of the process discussed above, with reference to FIGS. 1 and 7. FIG. 7 is a flowchart showing an authentication process of the authentication device 1 of the present embodiment.

If the number of user inputs matches the predetermined number of inputs (YES in S5 in FIG. 6), then the number-of-input determining section 8 of the authenticating section 7 obtains, from the user information obtaining section 6, the number of number keys that are pressed simultaneously and the number of simultaneous inputs, and compares the number of number keys that are pressed simultaneously, with the number of simultaneous inputs to determine whether or not the number of number keys matches the number of simultaneous inputs (S8). If the number of number keys does not match the number of simultaneous inputs (NO in S8), then the number-of-input determining section 8 transmits, to the display input device 3, the information about authentication failure, and causes the error message to be displayed. The error message to be shown on the display input device 3 may be either of a message informing that the number of simultaneous inputs is incorrect and a message informing of the authentication failure.

If the number of number keys matches the number of simultaneous inputs (YES in S8), then the number-of-input determining section 8 provides this information to the calculating section 9. When receiving the information that is provided by the number-of-input determining section 8 and indicates that the number of number keys matches the number simultaneous inputs, the calculating section 9 obtains, from the user information obtaining section 6, the numerical values that are entered simultaneously and the calculation method, and performs calculation according to the calculation method by use of the numerical values that are entered simultaneously, thereby determining the input password (S9).

Thereafter, the calculating section 9 provides the input password thus determined, to the password verifying section 10. The password verifying section 10 obtains the user ID from the user information obtaining section 6, and obtains, from the user information DB 5 via networks, the verification password that corresponds to the user ID. The password verifying section 10 verifies the input password obtained from the calculating section 9, against the verification password (S10).

Thereafter, if determining as a result of this verification in 510 that the input password matches the verification password (YES in S6 in FIG. 6), then the password verifying section 10 provides this information to the post-authentication processing section 11. If, as described earlier, determining that the output value does not match the verification password (NO in S6), then the password verifying section 10 transmits this information about authentication failure to the display input device 3 and causes the display input device 3 to show an error messages (S7 in FIG. 6).

Note that although the present embodiment discusses the foregoing case in which the number of user inputs and the predetermined number of inputs are compared in S5, and the number of number keys that are pressed simultaneously and the number of simultaneous inputs are compared in S8, it is also possible to carry out S5 and S8 on the other way around. Specifically, the numerical values of the number keys that are pressed simultaneously and the number of simultaneous inputs may be compared in S5, and the number of user inputs and the predetermined number of inputs may be compared in S8.

Concretely, the user information obtaining section 6 determines in S5, by comparing the number of simultaneous inputs and the number of number keys that are pressed simultaneously, whether or not the number of the number keys that are pressed simultaneously matches the number of simultaneous inputs. If the number of number keys that are pressed simultaneously matches the number of simultaneous inputs (YES in S5), then the number-of-input determining section 8 of the authenticating section 7 obtains in S8, from the user information obtaining section 6, the number of number keys that are pressed simultaneously and the number of simultaneous inputs, and compares the number of user inputs to the predetermined number of inputs. If the number-of-input determining section 8 determines that the number of user inputs matches the predetermined number of inputs (YES in S8), then the process moves to S9. On the other hand, if the number-of-input determining section 8 determines that the number of user inputs does not match the predetermined number of inputs, then the process returns to the operation in S4 (NO in S8).

If determining that the number of number keys that are pressed simultaneously does not match the number of simultaneous inputs (NO in S5), then the user information obtaining section 6 transmits, after the user has entered all numerical values, the information about authentication failure to the display input device 3 and causes the display input device 3 to show the error message. Causing the display input device 3 to show the error message after the user has entered all numerical values makes it possible to prevent the number of simultaneous inputs from being figured out by the third parties. The error message to be shown on the display input device 3 may be either of a message informing that the number of simultaneous inputs is incorrect and a message informing of the authentication failure.

The verification password that corresponds to the user ID “0001” is “1234”. To match the input password and the verification password, the numerical values that are to be entered simultaneously may be arranged as shown in FIG. 8, for example. Note that it is assumed that if the user ID is “0001”, the calculation method is set to “addition”, and the number of simultaneous inputs is set to “2” as shown in FIG. 4.

Thus, as shown in FIG. 8, the numerical values are entered as follows. The input value 1 “4” and the input value 2 “7” are entered simultaneously to enter the first digit. The input value 1 “4” and the input value 2 “8” are entered simultaneously to enter the second digit. The input value 1 “6” and the input value 2 “7” are entered simultaneously to enter the third digit. The input value 1 “0” and the input value 2 “4” are entered simultaneously to enter the fourth digit. Accordingly, the input value 1 and the input value 2 of each digit are added, and the last digit of the value obtained by this addition is adopted as the input password, whereby the input password is determined as “1234”. It goes without saying that the way to determine the input password as “1234” is not limited to the foregoing way.

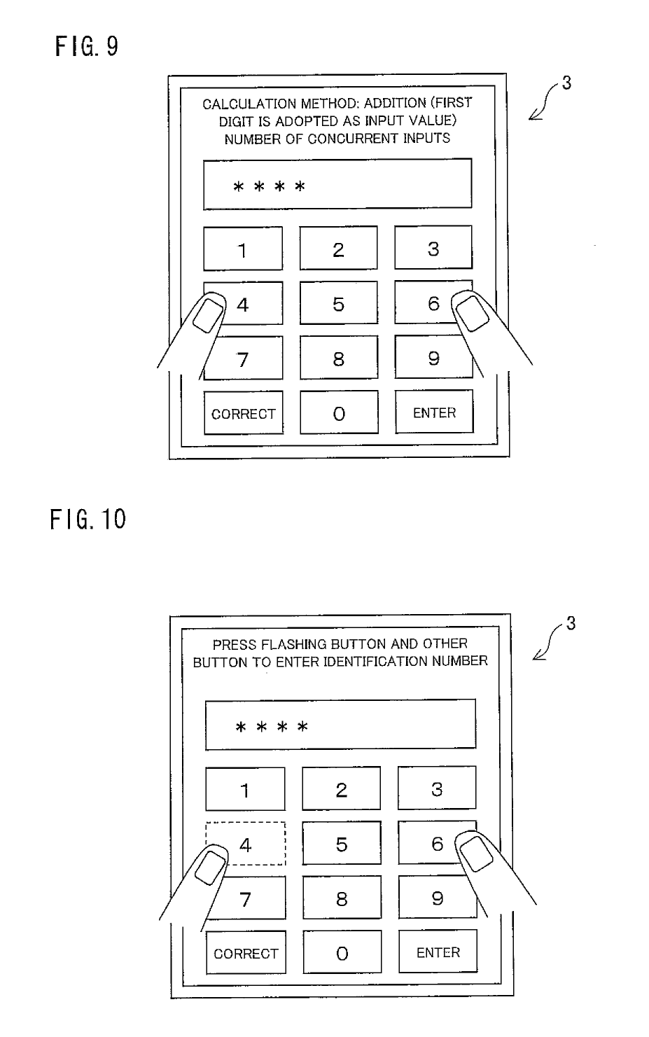

Note that although the present embodiment discusses the case in which the calculation method and the number of simultaneous inputs are set in advance by the user and stored in the user information DB 5 in such a way as to be associated with the user ID, the present invention is not limited to this embodiment. The following configuration is also possible. Specifically, only the verification password is determined in advance, and only the user ID and the verification password are associated and stored in the user information DB 5. After obtaining the user ID from the user ID obtaining section 2, the user information obtaining section 6 specifies, to the user, the calculation method and the number of simultaneous inputs on the information entry screen of the display input device 3, as shown in FIG. 9.

In this case, the user first needs to be given the calculation method and the number of simultaneous inputs by the user information obtaining section 6, in order to perform calculation to derive the password. Thus, it is preferable to create user-friendly environment, such as displaying a list of calculation equations and calculation results near the display input device 3.

Further, although the verification password is set for each user in the present embodiment, the present invention is not limited to this configuration. The same single verification password may be set for all users. In this case, the user ID obtaining section 2 may be omitted, as long as a table on which the calculation method and the number of simultaneous inputs are associated is stored in the user information DB 5. The verification password may be set in advance in the password verifying section 10.

As the foregoing describes, the authentication device 1 of the present embodiment is adapted so that the authentication device 1 includes: input means for obtaining plural numerical values of plural keys, which plural numerical values are entered simultaneously via the plural keys; calculating means for determining an input password by performing calculation according to a predetermined calculation method by use of the plural numerical values obtained by the input means; and verifying means for verifying the input password determined by the calculating means, against a verification password that is determined in advance.

The user enters plural number keys simultaneously, and the authentication device 1 of the present embodiment performs calculation according to the predetermined calculation method by use of the numerical values that are entered simultaneously, whereby the input password is determined. The authentication device 1 verifies the input password against the verification password that is determined in advance. In other words, to enter the password, the user simultaneously enter plural numerical values that are different from the password are entered simultaneously in the present invention, while the user enters each digit of the password conventionally.

Since the number keys that are to be entered simultaneously by the user are not the input password itself, it is possible to prevent the password from being stolen by the third parties even if the third parties see the movement of the fingers and the arms of the user. Further, since the user enters plural number keys simultaneously, it is difficult for the third parties to identify which number keys are pressed, when trying to figure out the input value by looking at the movement of the fingers and arms of the user. This makes it possible to prevent the input value from being stolen easily by the third parties.

Further, even if the password itself is known by the third parties through memos or the Internet, the third parties are unable to enter appropriate numerical values to derive the password unless the third parties know the calculation method to obtain the password. This makes it possible to prevent the password from being stolen easily by the third parties.

Further, although the number of number keys that the user need to press is a lot, the password that the user needs to memorize may be a simple password of numerical values that are easy to memorize, in the same manner as in conventional methods. This, therefore, does not give burden on the user and is convenient for the user.

As described earlier, the authentication device 1 of the present embodiment is adapted so that the user enters plural number keys simultaneously, and the input password is determined on the basis of the input value using the calculation method that is determined in advance. The user needs to either memorize in advance the numerical values that are to be entered simultaneously and calculated by the authentication device 1 to calculate the input password, or determine the numerical values at the time of entering the numerical values.

Thus, the authentication device 1 may include an input instructing section (not illustrated) in the information processing section 4 to specify, to the user, at least one of the plural number keys that are to be pressed simultaneously, on the information entry screen shown on the display input device 3. The number keys that are to be pressed simultaneously may be specified to the user by flushing the number keys, changing colors, or lighting the number keys. Further, text may be displayed on an area other than the number keys to specify, to the user, the number keys that are to be entered simultaneously. In other words, the input instructing section may employ any ways to specify, to the user, the number keys that are to be pressed simultaneously, as long as the user can understand the specified number keys that should be entered.

FIG. 10 illustrates a configuration in which the input instructing section causes one number key to flush on the information entry screen shown on the display input device 3 of the authentication device 1. In FIG. 10, the input instructing section causes the number key “4” on the information entry screen shown on the display input device 3. For example if the user desires to enter 0 as the input password when the number of simultaneous inputs is 2 and the calculation method is addition, the user may press the number key “4”, which is caused to flush by the input instructing section, and the number key “6” simultaneously so that 0 is obtained as a result of this addition.

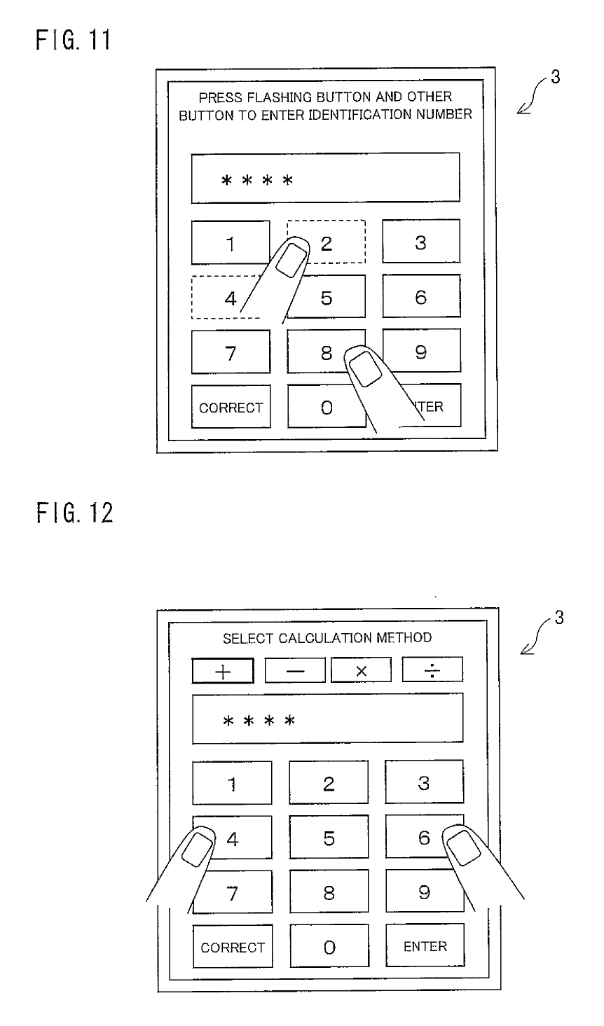

Further, the input instructing section may cause not only one number key to flush as described above, but also plural number keys to flush. FIG. 11 illustrates a configuration in which the input instructing section causes the plural number keys to flush on the information entry screen shown on the display input device 3 of the authentication device 1.

In FIG. 11, the input instructing section causes the number keys “2” and “4” on the information entry screen shown on the display input device 3. For example if the user desires to enter “0” as the input password when the number of simultaneous inputs is “2” and the calculation method is “addition”, the user may choose one of the number keys “4” and “2”, which are caused to flush by the input instructing section, to press simultaneously with pressing a number that produces 0 as a result of the addition.

As the foregoing describes, the authentication device 1 includes the input instructing section to specify, to the user, at least one of the plural number keys that should be entered simultaneously. Thus, taking the numerical values specified and the calculation method into consideration, the user only needs to figure out the remaining numerical value to make the inputs. This makes it possible to reduce the burden on the user of deciding the combination of number keys to press, facilitating the user to enter plural number keys simultaneously.

Further, the calculation method or the number of simultaneous inputs may be selectable by the user on the information entry screen shown on the display input device 3. FIG. 12 illustrates a configuration in which the calculation method is selectable on the information entry screen shown on the display input device 3 of the authentication device 1. If the calculation method is arranged to be selectable as shown in FIG. 12, it becomes possible to change the calculation method each time the numerical values are entered simultaneously to determine a digit of the input password. It is possible to arrange in such a manner that only the number of simultaneous inputs is selectable, or in such a manner that both of the calculation method and the number of simultaneous inputs are selectable.

Further, it is also possible to arrange in such a manner that, if the user does not desire to use a method that is as high in security level as the authentication method of the present embodiment, the authentication method in the authentication device 1 of the present embodiment may be switched to a conventional authentication method on information entry screen of the display input device 3, whereby the user can enter the password by use of the conventional authentication method.

The configuration may be as follows. When the user chooses a conventional way of authentication, the user information obtaining section 6 obtains the user ID from the user ID obtaining section 2 and provides the user ID to the password verifying section 10. Then, the password verifying section 10 obtains the verification password from the user information DB 5, obtains the input password entered by the user via the display input device 3, and verifies the input password against the verification password.

It is possible to configure the respective blocks of the authentication device 1, especially the user information obtaining section 6, the number-of-input determining section 8 and the calculating section 9, with either of hardware logic and software using CPU as discussed below.

Specifically, the authentication device 1 include CPU (central processing unit), which executes commands of control programs for realizing respective functions, ROM (read only memory) storing the control programs, RAM (random access memory) to store the control programs in executable formats, and a storage unit (recording medium), such as a memory, storing the programs and various data. An object of the present invention is achievable by providing the authentication device 1 with a computer-readable recording medium that stores program codes (execute form program, intermediate code program, source program) of the control programs of the authentication device 1, which control programs are the software for realizing the functions discussed above, and causing the computer (or CPU or MPU) to read and execute the program codes stored in the recording medium.

The following are examples of the recording medium: a tape such as a magnetic tape and a cassette tape; a disk such as an magnetic disk (e.g. floppy (registered trademark) disk, hard disk) and an optical disk (e.g. CD-ROM, MO, MD, DVD, CD-R); a card such as an IC card (including memory card) and an optical card; and a semiconductor memory such as a mask ROM, an EPROM, an EEPROM, and a flash ROM.

Further, the authentication device 1 may be configured so as to be connectable with communication networks to supply the program codes via the communication networks. The communication networks are not particularly limited. For example, the Internet, intranet, extranet, LAN, ISDN, VAN, CATV communication networks, virtual private networks, telephone line networks, mobile communication networks, or satellite communication networks may be employed. Further, the transmission media that constitute the communication networks are not particularly limited. For example, a wire transmission medium, such as IEEE 1394, USB, power carriers line, cable TV circuits, telephone lines, ADSL circuits, and wireless transmission media, such as infrared rays (e.g. IrDA, remote-controller), Bluetooth (registered trademark), IEEE 802.11, HDR, mobile telephone networks, satellite circuits, or terrestrial digital networks may be employed. The present invention is also realizable in the form of computer data signals that are concretized by electrical transmission of the program codes and embedded in carriers.

The present invention is not limited to the description of the embodiments above, but may be altered by a skilled person within the scope of the claims. An embodiment based on a proper combination of technical means disclosed in different embodiments is encompassed in the technical scope of the present invention.

As the foregoing describes, the authentication device of the present invention may include user identification information obtaining means for obtaining user identification information to identify a user, the verifying means reading out, from a storage section, the verification password that is stored in advance in such a way as to be associated with the user identification information obtained by the user identification information obtaining means, and verifying the input password against the verification password.

With this configuration, the user identification information obtaining means for obtaining the user identification information is included. The user identification information and various pieces of information are associated and stored in the storage section to allow respective means of the authentication device of the present invention to utilize information that corresponds to respective users. Specifically, the user identification information and the predetermined verification password are associated and stored in advance in the storage section so that, when verifying the input password against the verification password, the verifying means can obtain, from the storage section, the verification password that corresponds to the user identification information. Since the verification password is stored in such a way as to be associated with the user identification information, it is possible to set the verification password for each user.

Further, the calculating means of the authentication device of the present invention may determines the input password by reading out, from the storage section, the calculation method that is stored in advance in such a way as to be associated with the user identification information obtained by the user identification information obtaining means, and performing calculation according to the calculation method by use of the numerical values obtained by the input means.

With this configuration, the user identification information and the predetermined calculation method are associated and stored in advance in the storage section. This allows the calculating means to obtain the calculation method corresponding to the user identification information when performing calculation by use of the numerical values obtained by the input means. Since the calculation method is stored in such a way as to be associated with the user identification information, it is possible to set the calculation method for each user. This makes it further difficult for the third parties to figure out the calculation method for calculating the input password. Thus, even if the password itself is known by the third parties, it is still possible to prevent the password from being missed easily by the third parties.

Further, the authentication device of the present invention may include number-of-input determining means for determining whether or not the number of keys that are entered simultaneously matches the predetermined number of simultaneous inputs, the calculating means determining the input password if the number of keys matches the predetermined number of simultaneous inputs.

With this configuration, the input determining means causes the calculating means to determine the input password only if it is determined that the number of number keys matches the predetermined number of simultaneous inputs. Thus, unless the number of number keys does matches the predetermined number of simultaneous inputs, the input password is determined.

Therefore, even if the password is known by the third parties through memos or the Internet, the third parties cannot determine the input password unless the third parties know not only the calculation method for determining the password but also the number of number keys that are to be pressed simultaneously. Thus, even if the password itself is known by the third parties, it is still possible to prevent the password from being missed easily by the third parties.

Further, the number-of-input determining means of the authentication device of the present invention may read out the number of simultaneous inputs from the storage section, which number is stored in advance in such a way as to be associated with the user identification information obtained by the user identification information obtaining means, and compares the number of simultaneous inputs with the number of keys that are entered simultaneously.

With this configuration, the user identification information and the predetermined number of simultaneous inputs are associated and stored in advance in the storage section. This allows the number-of-input determining means to obtain the number of simultaneous inputs that corresponds to the user identification information, when comparing the number of simultaneous inputs to the number of number keys that are pressed simultaneously. Since the number of simultaneous inputs is stored in such a way as to be associated with the user identification information, it is possible to set the number of simultaneous inputs for each user. This makes it further difficult for the third parties to figure out the number of number keys that are to be pressed simultaneously. Thus, even if the password itself is known by the third parties, it is still possible to prevent the password from being missed easily by the third parties.

Further, the authentication device of the present invention may include entry specifying means for specifying, to a user, at least one of the plural keys that are to be pressed simultaneously.

In order for the user to enter the plural input values simultaneously via the plural number keys and to determine the input password using the predetermined calculation method by use of the input values, the user needs to either memorize or decide each time the numerical values that are to be entered simultaneously to cause the authentication device to calculate the numerical values that constitute the input password.

With the foregoing configuration of the present invention, the entry specifying means specifies, to the user, at least one of the plural number keys that need to be entered simultaneously. Thus, taking the numerical values specified and the calculation method into consideration, the user only needs to figure out the remaining numerical value to make the inputs. This makes it possible to reduce the burden on the user of deciding the combination of number keys to press, facilitating the user to enter plural number keys simultaneously.

The authentication device is also realizable by a computer. In this case, an authentication program causing a computer to operate as the respective means to realize the authentication device on the computer, and a computer-readable recording medium storing the program are also encompassed in the scope of the present invention.

The authentication device of the present invention is suitably installed in devices that require passwords to be entered for authentication, such as ATM, PC, mobile phones and the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An authentication device, comprising:
input means for obtaining plural numerical values of plural keys, which plural numerical values are entered simultaneously via the plural keys;
calculating means for determining an input password by performing calculation according to a predetermined calculation method by use of the plural numerical values obtained by the input means; and
verifying means for verifying the input password determined by the calculating means, against a verification password that is determined in advance.

2. The authentication device of claim 1, wherein, on the basis of the plural numerical values that are entered simultaneously, the calculating means determines at least one of plural numerical characters constituting the input password.

3. The authentication device of claim 1, further comprising user identification information obtaining means for obtaining user identification information to identify a user,
the verifying means reading out, from a storage section, the verification password that is stored in advance in such a way as to be associated with the user identification information obtained by the user identification information obtaining means, and verifying the input password against the verification password.

4. The authentication device of claim 1, wherein the input means obtains the plural numerical values of plural number keys, which plural numerical values are entered simultaneously via the plural number keys.

5. The authentication device of claim 3, wherein the calculating means determines the input password by reading out, from the storage section, the calculation method that is stored in advance in such a way as to be associated with the user identification information obtained by the user identification information obtaining means, and performing calculation according to the calculation method by use of the numerical values obtained by the input means.

6. The authentication device of claim 3, further comprising number-of-input determining means for determining whether or not the number of keys that are entered simultaneously matches the predetermined number of simultaneous inputs,
the calculating means determining the input password if the number of keys matches the predetermined number of simultaneous inputs.

7. The authentication device of claim 6, wherein the number-of-input determining means reads out the number of simultaneous inputs from the storage section, which number is stored in advance in such a way as to be associated with the user identification information obtained by the user identification information obtaining means, and compares the number of simultaneous inputs with the number of keys that are entered simultaneously.

8. The authentication device of claim 1, further comprising entry specifying means for specifying, to a user, at least one of the plural keys that are to be pressed simultaneously.

9. An authentication method, comprising:
an entry step of obtaining plural numerical values of plural keys, which plural numerical values are entered simultaneously via the plural keys;
a calculation step of determining an input password by performing calculation according to a predetermined calculation method by use of the plural numerical values obtained in the entry step; and
a verification step of verifying the input password determined in the calculation step, against a verification password that is determined in advance.

10. An authentication program for causing a computer to execute:
an entry process of obtaining plural numerical values of plural keys, which plural numerical values are entered simultaneously via the plural keys;
a calculation process of determining an input password by performing calculation according to a predetermined calculation method by use of the plural numerical values obtained in the entry process; and
a verification process of verifying the input password determined in the calculation process, against a verification password that is determined in advance.

11. A computer-readable recording medium, storing an authentication program for causing a computer to execute:
an entry process of obtaining plural numerical values of plural keys, which plural numerical values are entered simultaneously via the plural keys;
a calculation process of determining an input password by performing calculation according to a predetermined calculation method by use of the plural numerical values obtained in the entry process; and
a verification process of verifying the input password determined in the calculation process, against a verification password that is determined in advance.
